(19) United States
(12) Patent Application Publication
(10) Pub. No.: US 2005/0235496 A1
(43) Pub. Date: Oct. 27, 2005

(54) Pistachio nut opener

(76) Inventors: Joseph Victor Shagday, El Dorado Hills, CA (US); Lucy Lee Shagday, El Dorado Hills, CA (US)

Correspondence Address: Risto A. Rinne, Jr.;Complete Patenting Services, Suite E, 2173 East Francisco Boulevard, San Rafael, CA, 94901, US

(21) Appl. No.: 10/833,471

(22) Filed: Apr. 27, 2004

(51) Int. Cl. A23N 5/00

(52) U.S. Cl. 30/120.2; 30/315

(57) ABSTRACT

An apparatus for opening pistachio nuts includes a planar handle that includes a length that is greater than a width and a width that is greater than a thickness. The planar handle includes an area adapted for advertising. A protrusion that resembles a blade of a flat blade screwdriver is attached, where desired, to the planar handle and is used to pry open the pistachio nuts.

### BACKGROUND OF THE INVENTION

1. Field of the Invention

The present invention, in general relates to edible nuts and, more particularly, to a device for opening a pistachio nut.

There is a long standing need for an effective and economical pistachio nut opener. People who eat pistachio nuts typically eat large numbers of them at each occurrence. It is difficult to use a fingernail to open a pistachio nut. Doing so is prone to damaging the fingernail as well.

There is only one known type of a pistachio nut opener that resembles a nickel with a flat protrusion that requires the user to apply significant torque in order to open the pistachio nut. The known device is also expensive, costing approximately $25.00 per unit.

Accordingly, there exists today a need for a pistachio nut opener that ameliorates the aforementioned difficulties.

Clearly, such an apparatus would be a useful and desirable device.

2. Description of Prior Art

A type of a pistachio nut opener is known as was described hereinabove and which is believed to be described in U.S. Pat. No. 4,317,281.

While the structural arrangements of the above described device may, at first appearance, have similarities with the present invention, it differs in material respects. These differences, which will be described in more detail hereinafter, are essential for the effective use of the invention and which admit of the advantages that are not available with the prior devices.

### OBJECTS AND SUMMARY OF THE INVENTION

It is an object of the present invention to provide a pistachio nut opener that is economical to manufacture.

It is also an important object of the invention to provide a pistachio nut opener that is easy to use.

Another object of the invention is to provide a pistachio nut opener that is adapted to split apart the shell surrounding a pistachio nut.

Still another object of the invention is to provide a pistachio nut opener that is sufficiently economical to be included in packages of unshelled pistachio nuts.

Still yet another object of the invention is to provide a pistachio nut opener that is adapted for a single use and which is disposable.

Yet another important object of the invention is to provide a pistachio nut opener that includes an elongated handle.

Still yet another important object of the invention is to provide a pistachio nut opener that provides increased torque for opening a pistachio nut.

A first continuing object of the invention is to provide a pistachio nut opener that can be reused for a limited time.

A second continuing object of the invention is to provide a pistachio nut opener that includes an elongated handle which provides increased torque for opening a pistachio nut.

A third continuing object of the invention is to provide a pistachio nut opener that includes an elongated handle which provides an area for advertising.

Briefly, a pistachio nut opener that is constructed in accordance with the principles of the present invention has a planar handle that includes a length that exceeds its width and a width that exceeds its thickness. A minimum size for the planar handle includes a thickness not less than 1/32 of an inch, a width not less than ¼ of an inch and a length not less than 1 and ½ inches. This provides an area for advertising and a length that supplies sufficient torque to allow easy opening of the pistachio nut. A tapered blade is attached where desired to the planar handle. The tapered blade resembles the blade portion of a flat-blade screwdriver and is preferably attached at one end of the planar handle and at an angle with respect thereto.

### BRIEF DESCRIPTION OF THE DRAWING

FIG. 1 is a side view of the pistachio nut opener.

FIG. 2 is a view of the pistachio nut opener taken along the line 2-2 of FIG. 1.

### DETAILED DESCRIPTION OF THE INVENTION

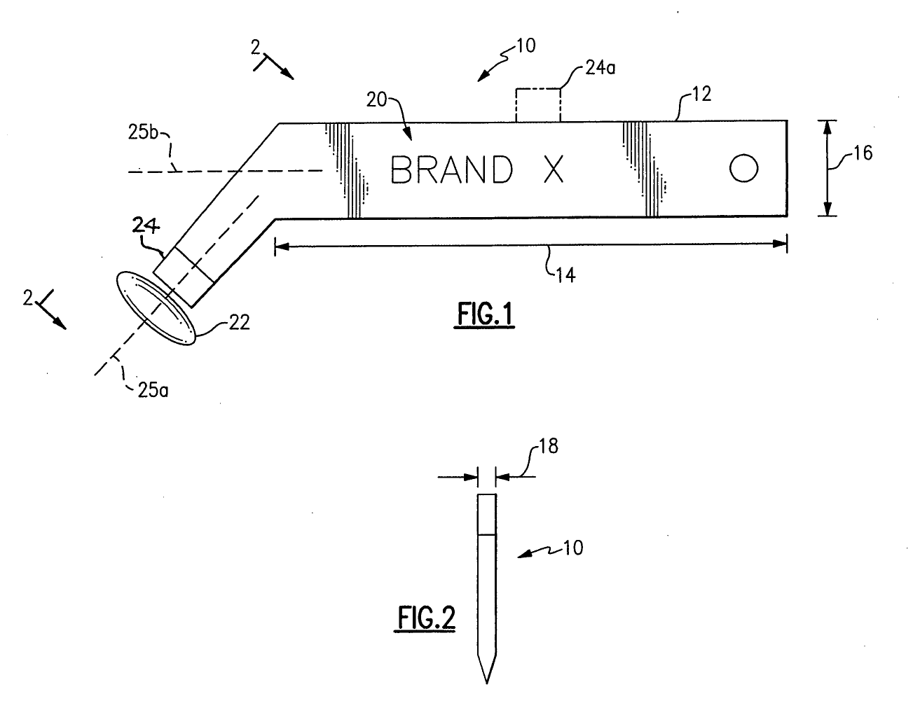

Referring to FIGS. 1 and 2, is shown a pistachio nut opener, identified in general by the reference numeral 10.

The pistachio nut opener 10 has a planar handle 12 that includes a length 14 that exceeds a width 16 and the width 16 that exceeds a thickness 18.

A minimum size for the planar handle 12 includes the thickness 18 of not less than 1/32 of an inch, the width 16 of not less than ¼ of an inch and the length 14 of not less than 1 and ½ inches.

This provides an area for advertising, identified in general by the reference numeral 20, on a first and opposite second side of the handle 12. The advertising will typically include any brand name that is desired.

One possible use is for those who sell pistachio nuts 22 (only the one pistachio nut 22 is shown) to include one of the pistachio nut openers 10 in the same container (not shown) that contains the plurality of pistachio nuts 22.

Having the pistachio nut opener 10 in the container would make it easier for consumers to open the pistachio nuts 22. This, in turn, would make the container that includes the pistachio nut opener 10, which is otherwise identical to a competing container, more desirable than the competing container. Consumers may even be willing to pay more for the container that includes the pistachio nut opener 10 over the competing container.

The pistachio nut opener 10 is preferably constructed of a hard plastic. While other materials are possible, plastic is inexpensive. Accordingly, when the pistachio nut opener 10 is manufactured in sufficient quantity and is made of plastic, the cost per unit may well be only a fraction of a penny per unit. Adding one to the container becomes relatively easy and inexpensive to do, especially if it can boost sales.

A more durable version of the pistachio opener 10 can of course be constructed of any other preferred material, including any composite material or metal. Of course, a more durable version would cost more and would likely be a retail product available for sale of its own. It is always possible that a “high-end” gourmet pistachio nut manufacturer, distributor, or retailer may include the more durable version with their product, as well.

In any event, the advertising area 20 allows the pistachio nut manufacturer, distributor, or retailer to advertise their particular “brand” on the pistachio nut opener 10.

Using the pistachio nut opener 10 that is supplied in the container is likely to please the consumer. Every time the consumer uses the pistachio nut opener, he or she will be reminded of the source (i.e., the manufacturer, distributor, or retailer) that put the opener 10 in the container.

An incredibly positive environment for associating the source with a product is thereby provided. As such, the manufacturer, distributor, or retailer would likely find considerable value in including at least one of the pistachio nut openers 10 in each container.

It is also possible that even a less-durable version of the pistachio nut opener 10 could last for an extended period of time beyond that necessary to open all of the pistachio nuts 22 in the container. The positive association with the source that appears on the area for advertising 20 would then occur for an extended period of time. An unexpected benefit is that the consumer would be reminded of the source, even when the consumer is opening pistachio nuts 22 that came from a competing source.

A tapered blade 24 is attached where desired to the planar handle 12. The tapered blade 24 resembles the blade portion of a flat-blade screwdriver (not shown). A preferred location is at one end of the handle 12 and at a slight planar angle with respect thereto. The tapered blade 24 is on the same plane as the handle 12, just offset so that a first longitudinal axis 25a of the tapered blade 24 is at an angle with respect to a second longitudinal axis 25b of the handle 12.

The angle provides an ergonomically advantageous position for use. If desired, the tapered blade 24 could be eliminated and a modified tapered blade 24a (shown in dashed lines) could be added in the middle of the handle 12, or elsewhere, as desired.

The length 14 of the handle 12 is important. By having the length at least 1.5 inches, a user is easily able to insert the tapered blade 24 into the shell of the pistachio nut 22 at the split thereof and twist the handle 12 sufficient to separate and open the shell of the pistachio nut 22.

The length of the handle 12 supplies sufficient torque to allow easy opening of the pistachio nut 22 by even a person who is frail or elderly.

The invention has been shown, described, and illustrated in substantial detail with reference to the presently preferred embodiment. It will be understood by those skilled in this art that other and further changes and modifications may be made without departing from the spirit and scope of the invention which is defined by the claims appended hereto.

1. A pistachio nut opener, comprising:
(a) a handle having a length that is greater than a width; and
(b) a blade attached to said handle and wherein said handle is substantially planar and wherein said blade is attached at an end of said handle and wherein all of said blade is disposed on a same plane as said handle and wherein said blade includes a first longitudinal axis and wherein said handle includes a second longitudinal axis and wherein said first longitudinal axis and said second longitudinal axis are not parallel and wherein an angle extending from said second longitudinal axis to said first longitudinal axis includes an obtuse angle and wherein said blade is disposed at an end of said handle and wherein said blade is not adapted to pivot with respect to said handle or be separated apart from said handle and wherein said blade and said handle are formed of a continuous piece of material.

2. (canceled)

3. The pistachio nut opener of claim 1 wherein said length is at least 1.5 inches.

4. The pistachio nut opener of claim 1 wherein said width is at least one-quarter of an inch.

5. The pistachio nut opener of claim 1 wherein said handle includes a thickness that is at least 1/32 of an inch.

6. The pistachio nut opener of claim 1 wherein said length is at least 1.5 inches and wherein said width that is at least one-quarter of an inch and wherein said handle includes a thickness that is at least 1/32 of an inch.

7. (canceled)

8. (canceled)

9. (canceled)

10. (canceled)

11. (canceled)
